(19) United States
(12) Patent Application Publication
(10) Pub. No.: US 2006/0209445 A1
(43) Pub. Date: Sep. 21, 2006

(54) Magnetic disk drive and write current control method therein

(75) Inventors: Nobuyoshi Yamasaki, Kawasaki (JP); Toshiyuki Yokota, Kawasaki (JP); Masao Kondou, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/243,919

(22) Filed: Oct. 5, 2005

(30) Foreign Application Priority Data
Mar. 17, 2005 (JP) 2005-076721

(51) Int. Cl. G11B 5/09

(52) U.S. Cl. 360/46

(57) ABSTRACT

A magnetic disk drive and a write current control method are provided in which stable writing can always be carried out at the time of information writing without being subject to a thermal effect due to a write current. In the magnetic disk drive using a write head for writing a signal to a magnetic disk, it is determined when the signal writing is started, and upon determination of the start of the signal writing, a write current supplied to the write head is set in such a manner that the write current is large at the start of the signal writing and thereafter becomes smaller than that at the start of the signal writing.

### BACKGROUND OF THE INVENTION

1. Field of the Invention

The present invention relates to a magnetic disk drive for recording and playing data, information or the like by using a magnetic disk, and to a write current control method in such a magnetic drive.

2. Description of the Related Art

The write performance of a magnetic disk drive generally changes according to the temperature characteristics of a head, a recording medium and the like, so it is necessary to set a write current so as to match the temperature of an ambient environment. Thus, in the prior art, a threshold is set for each temperature, so that the setting can be changed so as to increase or decrease the write current, which has been beforehand adjusted to an appropriate value at room temperature, to an optimal value for each environmental temperature.

In this case, in low temperature environments, the coercive force of a recording medium into which information is written increases in comparison with that at room temperature, so writing becomes difficult. Therefore, the write current at low temperature is set to a current value higher or larger than that at room temperature, and on the contrary, in high temperature environments, the coercive force of the recording medium decreases in comparison with that at room temperature, so it becomes easy to write, but in order to prevent adverse influences such as side erasure due to write spreading, the write current is set to decrease.

Thus, in the past, the write current is set to adapt respective environmental temperatures, whereby a shortage of writing or insufficient writing at low temperature is improved, thereby coping with the reduction of side erasure due to write spreading at high temperature environments.

In magnetic disk drives, however, there has been known, as another factor apart from the environmental temperature, a phenomenon that magnetic poles are caused to protrude or project due to heat generated under the influence of a write current at the time of writing. In this case, writing can be done easily because the magnetic poles come nearer to a recording medium owing to their projection. Therefore, there arises a difference in write performance between at the start of writing at which the magnetic poles are not projected and after the magnetic poles have been projected, resulting in a variation in the frequency of errors at the time of information reading. This phenomenon becomes especially remarkable in particular at the time of starting writing in low temperature environments. In the above-mentioned known technique, no consideration has been given to such a thermal effect due to the write current, and hence, as stated above, a problem arises that the frequency of errors at the time of information reading is varied due to the difference in write performance between at the start of writing at which the magnetic poles are not projected and after the magnetic poles have been projected.

### SUMMARY OF THE INVENTION

Accordingly, the present invention is intended to obviate the problem as referred to above, and has for its object to provide a magnetic disk drive and a write current control method in a magnetic disk drive in which stable writing can always be carried out at the time of information writing without being subject to a thermal effect due to a write current.

In order to solve the above-mentioned problem, according to one aspect of the present invention, there is provided a magnetic disk drive using a write head for writing a signal to a magnetic disk, the magnetic disk drive comprising: a write start determination part that determines the start time of the signal writing; and a write current control part that sets a write current supplied to the write head in such a manner that the write current is large at the start of sad signal writing and thereafter becomes smaller than that at the start of the signal writing.

Preferably, the write current control part decreases the write signal from and after the start of the signal writing in a stepwise manner.

Preferably, the write current control part decreases the write signal from and after the start of the signal writing by using overshoot.

Preferably, the write current control part includes a write current rise mode in which the write current is set to a large value at the start of the signal writing, and thereafter set to be smaller than the large value at the start of the signal writing, and a write current normal mode in which the write current is not set to be large at the start of the signal writing.

Preferably, provision is further made for an environmental temperature detection part that detects the temperature of an ambient environment, and when the temperature detected by the environmental temperature detection part becomes lower than or equal to a predetermined value, the write current control part uses the write current rise mode.

Preferably, in case where the write signal is decreased from and after the start of the signal writing in a stepwise manner in the write current rise mode, the write current control part controls to make the magnitude of the write signal smaller or the speed at which the write signal is decreased in a stepwise manner greater when the temperature detected by the environmental temperature detection part is high than when it is low.

Preferably, provision is further made for a head flying height detection part that detects the flying height of the head, and when the flying height of the head detected by the head flying height detection part is greater than or equal to a predetermined value, the write current control part uses the write current rise mode.

Preferably, in case where the write signal is decreased from and after the start of the signal writing in a stepwise manner in the write current rise mode, the write current control part controls to make the magnitude of the write signal smaller or the speed at which the write signal is decreased in a stepwise manner greater when the flying height of the head detected by the head flying height detection part is low than when it is high.

According to another aspect of the present invention, there is provided a write current control method in a magnetic disk drive using a write head for writing a signal to a magnetic disk, the method comprising: a write start determination step of determining a start time of the signal writing; and a write current control step of setting, upon determination of the start of the signal writing in the write start determination step, a write current supplied to the write head in such a manner that the write current is large at the start of the signal writing and thereafter becomes smaller than the large value at the start of the signal writing.

As described in detail above, according to the present invention, there is achieved an advantageous effect that it is possible to constantly perform stable writing at the time of information writing without receiving a thermal effect due to a write current.

The above and other objects, features and advantages of the present invention will become more readily apparent to those skilled in the art from the following detailed description of preferred embodiments of the present invention taken in conjunction with the accompanying drawings.

### BRIEF DESCRIPTION OF THE DRAWINGS

FIG. 1 is a block diagram showing the construction of a magnetic disk drive according to one embodiment of the present invention.

FIG. 2 is a flow chart illustrating the operation of the magnetic disk drive according to the embodiment of the present invention.

FIG. 3 is a timing chart illustrating one example of a write current waveform in the embodiment of the present invention.

FIG. 4 is a timing chart illustrating one example of the write current waveform in a write current normal mode.

FIG. 5 is a timing chart illustrating another example (1) of the write current waveform in a write current rise mode.

FIG. 6 is a timing chart illustrating a further example (2) of the write current waveform in the write current rise mode.

FIG. 7 is a timing chart illustrating a still further example (3) of the write current waveform in the write current rise mode.

FIG. 8 is a timing chart illustrating a yet further example (4) of the write current waveform in the write current rise mode.

FIG. 9 is a timing chart illustrating write timing.

FIG. 10 is a timing chart illustrating an operation to decrease the write current in the write current rise mode.

FIG. 11 is a timing chart illustrating the beginning of writing (write start time) by means of a write signal.

### DESCRIPTION OF THE PREFERRED EMBODIMENT

Now, a preferred embodiment of the present invention will be described below in detail while referring to the accompanying drawings.

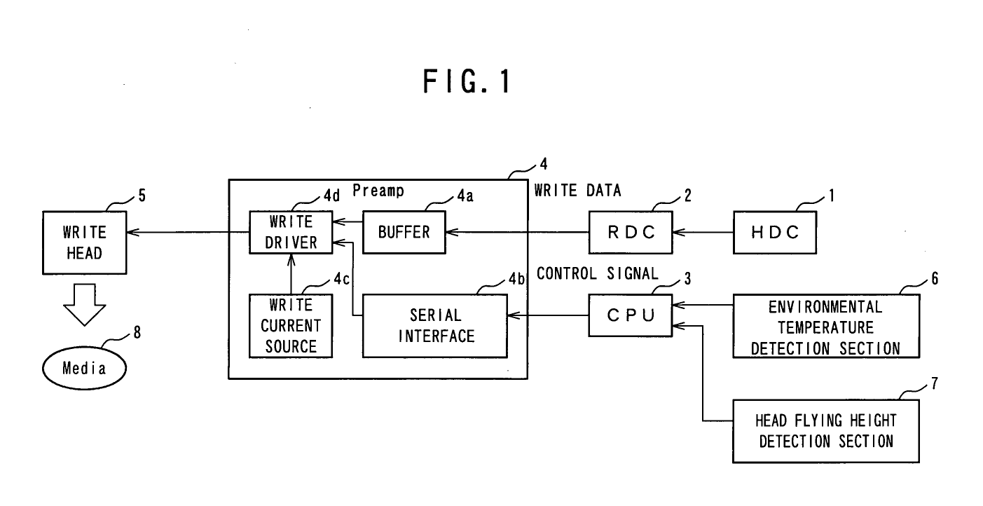

FIG. 1 is a block diagram that shows essential portions of a magnetic disk drive according to one embodiment of the present invention. The magnetic disk drive according to the present invention is provided with a hard disk controller (HDC) 1, a read channel (RDC) 2, a CPU 3, a preamplifier 4, a write head 5, an environmental temperature detection part 6, and a head flying height detection part 7.

The preamplifier 4 includes a buffer 4a that serves to temporarily store write data, a serial interface 4b to which serial data from the CPU 3 is input, and a write driver 4d that serves to send a write current from a write current source 4c to the write head 5 in the form of a magnetic head based on the write data stored in the buffer 4a.

In the above-mentioned construction, a brief explanation will be given to the flow of a signal at the time of writing in the magnetic disk drive.

First of all, an error correction code is added to each piece of record data sent from an unillustrated host system by means of the hard disk controller 1, and the record data with the error correction code thus added is then sent to the read channel (RDC) 2.

Inside the read channel 2, the record data received is converted into an appropriate form (e.g., randomizing of the data by scrambling, encoding and write comparison of the data by a modulation circuit, etc.), and the write data thus converted is input to the preamplifier 4. In the preamplifier 4, a write current is supplied to the write head 5 in accordance with the input write data, so that a signal is thereby recorded into a storage medium 8. In this case, the magnitude of the write current supplied to the write head 5 is controlled by serial data from the CPU 3.

With the above-mentioned construction, the CPU 3 constitutes a write current control part and a write start determination part according to the present invention, and forms serial data so as to control the write current in a manner to be described later by properly using the temperature detected by the environmental temperature detection part 6 and the head flying height detected by the head flying height detection part 7.

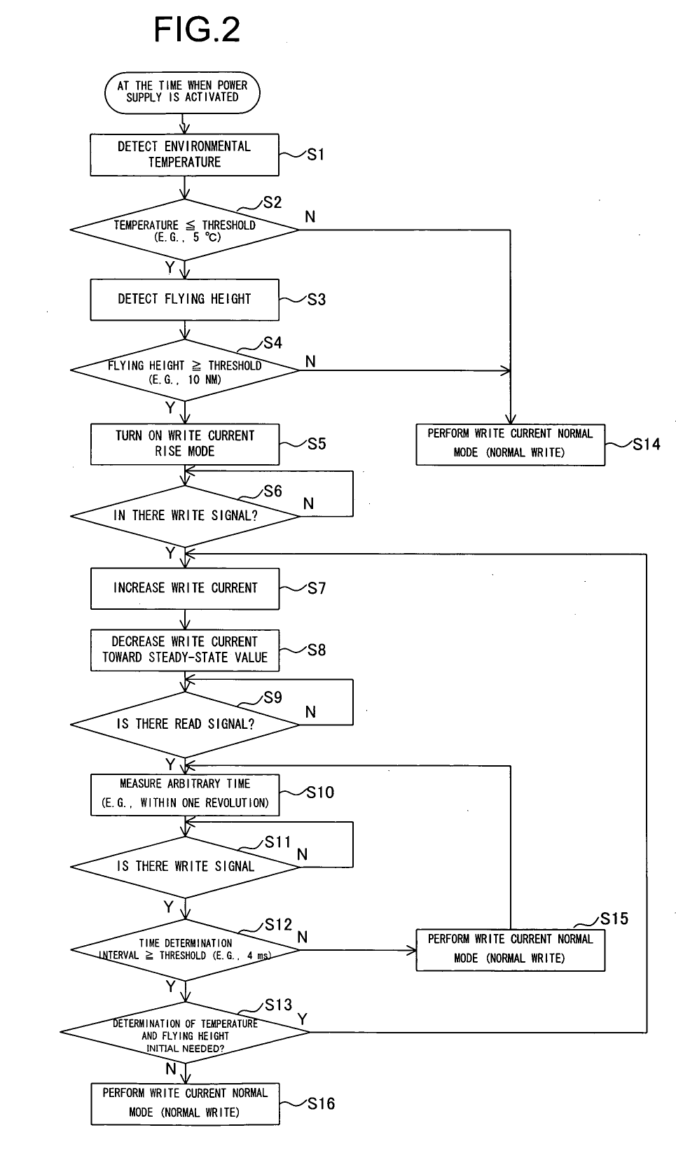

Next, reference will be made to the operation of the CPU 3 (the write current control part) forming serial data by using a flow chart illustrated in FIG. 2.

When a power supply is turned on, the temperature of an ambient environment (hereinafter also referred to as an environmental temperature) is detected by the environmental temperature detection part 6 (step S1), and it is determined whether the environmental temperature is lower than or equal to a predetermined threshold (e.g., 5° C.) (step S2). When it is determined that the environmental temperature is lower than or equal to the predetermined threshold (Y in step S2), the flying height of the head is then detected by the head flying height detection part 7 (step S3), and it is determined whether the flying height of the head is greater than or equal to a predetermined threshold (e.g., 10 nm) (step S4). When it is determined that the flying height is greater than or equal to the predetermined threshold (Y in step S4), a determination is made that the amount of projection of the magnetic poles is small, and a write current rise mode is turned on (step S5).

Based on the presence of a write signal, a determination is made that writing is started (step S6), and when it is determined that there is a write signal (Y in step S6), the write current is made to rise (increase) (step S7), after which it is decreased in a stepwise manner up to the magnitude of the write current at normal time (the normal mode write current magnitude) (step S8). A specific method to first increase and then decrease the write current will be described later.

Then, based on the determination of the presence of a read signal, it is determined that writing has been terminated (Y in step S9), and a time is measured (step S10). As such a time to be measured, there can be used, for example, an arbitrary time in one revolution period of the disk. When a determination is made that there is again a write signal (Y in step S11), the time measured is determined (step S12). When the measured time is larger than or equal to a predetermined threshold (e.g., 4 ms), it is determined that writing is started (Y in step S12), and as in steps S2 and S3, the operation according to the write current rise (increase) mode is repeated by making a determination as to whether the temperature measured is lower than or equal to the predetermined temperature threshold as well as a determination as to whether the head flying height measured is greater than or equal to the predetermined flying height threshold.

On the other hand, when it is determined in step S2 that the environmental temperature is higher than the predetermined temperature threshold (N in step S2), and when it is determined in step S4 that the flying height is smaller than the predetermined flying height threshold (N in step S4), the write current rise mode is not entered, and writing without increasing the write current is executed as the write current normal mode (step S14). In addition, when it is also determined in step S12 that the time measured has not exceeded the predetermined threshold (N in step S12), the write current rise mode is not entered, and the write current normal mode is executed (steps S15 and S16), and writing without increasing the write current is performed.

Next, reference will be made to the write current rise mode. In the write current rise mode, the write current is set to be large at the start of writing of a write signal, and thereafter is set to be small. After having been set to be small, the write current becomes the same as that in the write current normal mode.

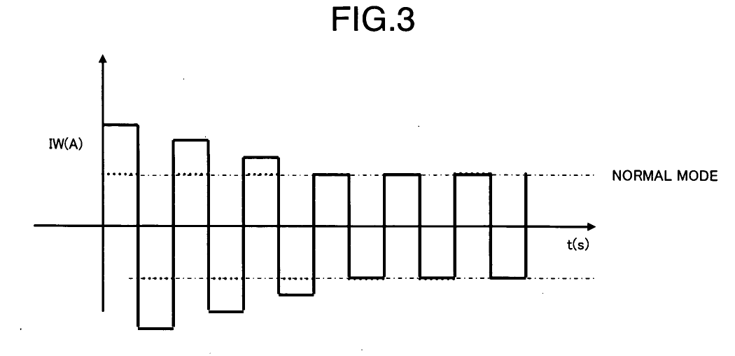

FIG. 3 illustrates the write current in the write current rise mode. In this example, the write current has a high rectangular wave at the start of writing, and thereafter the height of the rectangular wave is decreased in a stepwise manner up to the same magnitude as the height of the write current in the write current normal mode. Here, when a prescribed period of time (the number of servo samples or the number of sectors) in writing information into the recording medium has elapsed, an optimum magnitude of the write current (lower than the value previously set) for writing information into the following prescribed area of the medium is set so that information is continuously written therein.

Here, note that in this write current rise mode, the magnitude of the write signal can be made smaller or the speed at which the write signal is decreased in a stepwise manner can be made greater when the temperature detected by the environmental temperature detection part 6 is high than when it is low.

Also, the write signal can be made smaller or the speed at which the write signal is decreased in a stepwise manner can be made greater when the flying height detected by the head flying height detection part 7 is low than when it is high.

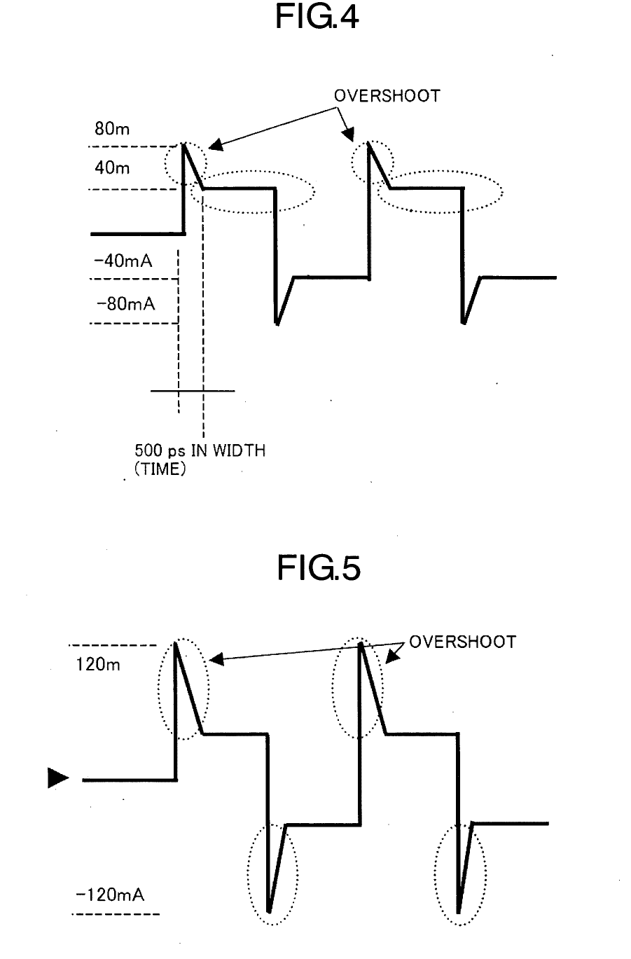

FIG. 4 through FIG. 8 are views that illustrate write current waveforms explaining cases where overshooting is used as another mode for raising or increasing a write current. FIG. 4 illustrates a write current in the write current normal mode. In this case, the write current becomes 80 mA at the rise of the current, thus generating an overshoot of 40 mA with respect to a steady-state write current of 40 mA. In contrast to this, FIG. 5 through FIG. 8 illustrate write current waveforms at the time when write currents rise or increase in the write current rise mode.

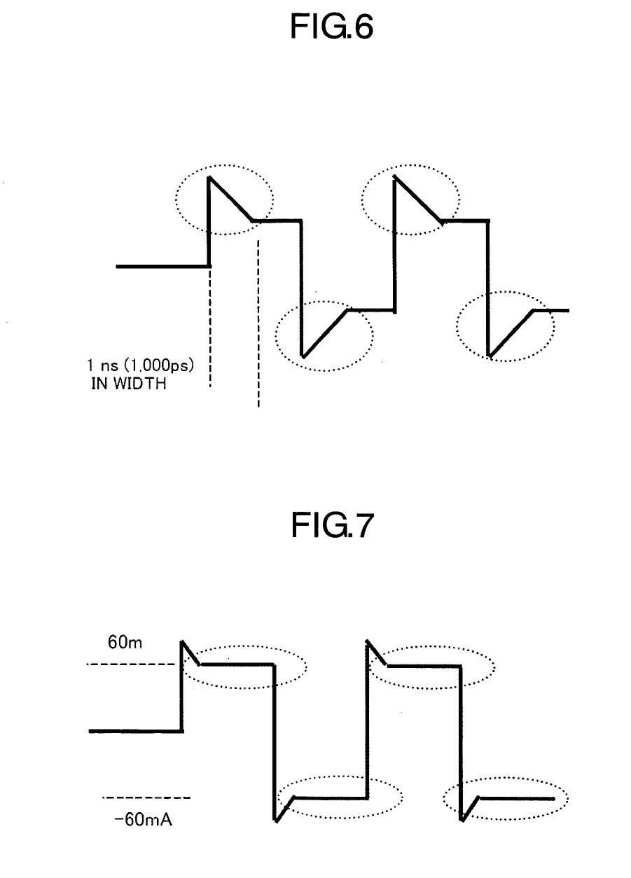

In FIG. 5, a maximum value of an overshoot at the time of rising of a write current is set to 120 mA and hence raised or increased by 40 mA with respect to the case of FIG. 4. In FIG. 6, by increasing a time constant for an overshoot to increase an average value of the current (effective value), energy is increased to raise the temperature of the magnetic poles. In FIG. 7, though an overshoot is not so large, the current value in the steady state is increased. In FIG. 8, both an overshoot and a steady-state current value are made to rise or increase.

Thus, by raising or increasing the current according to various modes, the heating of the magnetic poles due to the write current is facilitated whereby the magnetic poles are caused to project.

Next, reference will be made to the case where the write current is decreased in a stepwise manner when the overshoots are used, as shown in FIG. 5 through FIG. 8.

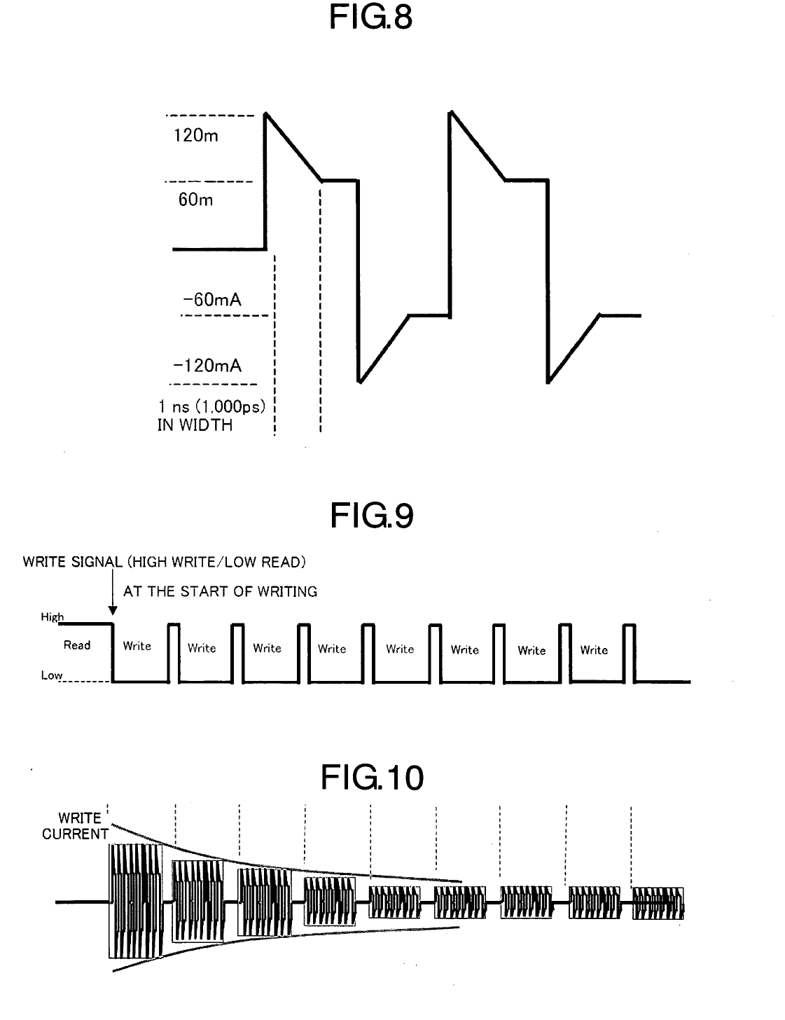

FIG. 9 illustrates a write signal. A write operation is carried out in a period in which the write signal is at a low state. FIG. 10 illustrates a write current for this situation. The write current is large at the beginning of writing (at the start of writing), and thereafter gradually decreases or converges to a steady-state value in a stepwise manner with a certain time constant. In this embodiment, assuming that a steady-state peak value of the write current is set to 100%, the write current is made to rise to 150% at the start of writing, and thereafter to decrease to 100% in a stepwise manner by 10% per write signal.

With the above construction, for example, the write current (the steady-state current value, and the amount and width of an overshoot) is caused to flow in a large amount (the setting of the amount of increase can be changed) at the start of writing, and a current amplification circuit (the settings of the time and the rate of decrease can be changed) with a property in which a current gradually decreases in the order of a few ms to a few hundred μs is arranged in the write driver in such a manner that it is operated when a certain value is set in a certain register of an IC that constitutes the write driver.

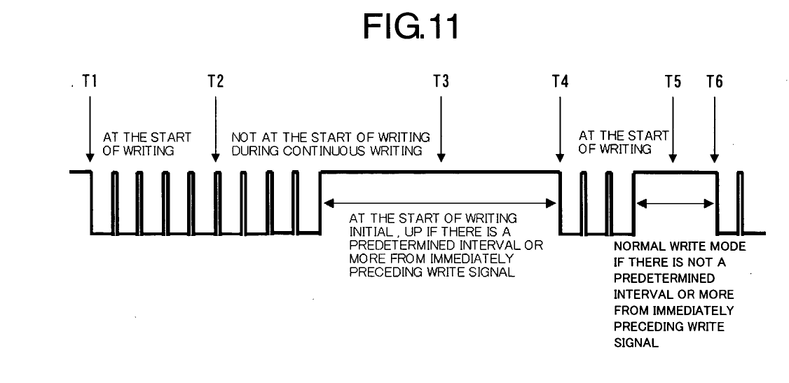

Next, reference will be made to a determination as to whether it is at the start of writing, while using FIG. 11. When a write signal has first been sent (T1), the CPU (write start determination part) 3 determines that it is at the start of writing. This is the operation of step S6 in FIG. 2. Then, when it is at the time of continuous writing (T2), it is determined that it is not at the start of writing. Thereafter, when a write signal has been sent at an interval (T4), if the interval is larger than or equal to a predetermined threshold (T3), it is determined that the write signal is at the beginning of writing (T4). This is the operation of step S11 in FIG. 2. On the other hand, if the interval is not larger than or equal to the predetermined threshold (T5), it is determined that the write signal is at the start of writing (T6).

As described in detail above, according to one aspect of the present invention, in order to improve write shortage at the time when the magnetic poles are not projected at the start of writing, the value of a write current (the steady-state current value, overshoot and width) is raised or increased only at the start of writing to facilitate the projection of the magnetic poles due to heat thereby to improve a write shortage at the time of writing, and thereafter the write current value is decreased in a stepwise manner according to a change in the amount of projection of the magnetic poles so as to converge to an optimum value, whereby the write current is optimized in all the write areas, thus making it possible to reduce the frequency of errors at the time of reading information. Further, a write current rise mode and a write current normal mode are provided, and the temperature of an ambient environment and the flying height of a head are detected, so that the write current rise mode or the write current normal mode can be alternatively selected according to the values of the environmental temperature and the head flying height thus detected. As a result, it is also possible to perform stable writing without regard to the environmental temperature, etc.

According to another aspect of the present invention, a write current control method is provided by the respective steps in the above-mentioned flow chart of FIG. 2. In addition, a write current control program can be provided by providing a program that makes a computer execute such a write current control method. By storing the above-mentioned program in a computer readable recording medium, it becomes possible to make the program executed by a computer that constitutes a magnetic disk drive.

Here, note that the computer readable recording medium includes a portable storage medium such as a CD-ROM, a flexible disk, a DVD disk, a magneto-optical disk, an IC card or the like, or a database that holds therein computer programs, or another computer and its database, or a transmission medium on a communication line.

While the invention has been described in terms of a preferred embodiment, those skilled in the art will recognize that the invention can be practiced with modifications within the spirit and scope of the appended claims.

What is claimed is:

1. A magnetic disk drive using a write head for writing a signal to a magnetic disk, said magnetic disk drive comprising:
a write start determination part that determines the start time of said signal writing; and
a write current control part that sets a write current supplied to said write head in such a manner that the write current is large at the start of sad signal writing and thereafter becomes smaller than that at the start of said signal writing.

2. The magnetic disk drive according to claim 1, wherein said write current control part decreases said write signal from and after the start of said signal writing in a stepwise manner.

3. The magnetic disk drive according to claim 1, wherein
said write current control part decreases said write signal from and after the start of said signal writing by using overshoot.

4. The magnetic disk drive according to claim 1, wherein said write current control part includes a write current rise mode in which said write current is set to a large value at the start of said signal writing, and thereafter set to be smaller than said large value at the start of said signal writing, and a write current normal mode in which said write current is not set to be large at the start of said signal writing.

5. The magnetic disk drive according to claim 4, further comprising an environmental temperature detection part that detects the temperature of an ambient environment, wherein when the temperature detected by said environmental temperature detection part becomes lower than or equal to a predetermined value, said write current control part uses said write current rise mode.

6. The magnetic disk drive according to claim 5, wherein in case where said write signal is decreased from and after the start of said signal writing in a stepwise manner in said write current rise mode, said write current control part controls to make the magnitude of said write signal smaller or the speed at which said write signal is decreased in a stepwise manner greater when the temperature detected by said environmental temperature detection part is high than when it is low.

7. The magnetic disk drive according to claim 4, further comprising: a head flying height detection part that detects the flying height of said head, wherein when the flying height of said head detected by said head flying height detection part is greater than or equal to a predetermined value, said write current control part uses said write current rise mode.

8. The magnetic disk drive according to claim 7, wherein in case where said write signal is decreased from and after the start of said signal writing in a stepwise manner in said write current rise mode, said write current control part controls to make the magnitude of said write signal smaller or the speed at which said write signal is decreased in a stepwise manner greater when the flying height of said head detected by said head flying height detection part is low than when it is high.

9. A write current control method in a magnetic disk drive using a write head for writing a signal to a magnetic disk, said method comprising:
a write start determination step of determining a start time of said signal writing; and
a write current control step of setting, upon determination of the start of said signal writing in said write start determination step, a write current supplied to said write head in such a manner that said write current is large at the start of said signal writing and thereafter becomes smaller than said large value at the start of said signal writing.

10. The write current control method in a magnetic disk drive according to claim 9, wherein in said write current control step, said write signal is decreased from and after the start of said signal writing in a stepwise manner.

11. The write current control method in a magnetic disk drive according to claim 9, wherein in said write current control step, said write signal is decreased from and after the start of said signal writing by using overshoot.

12. The write current control method in a magnetic disk drive according to claim 9, wherein said write current control step includes a write current rise mode execution step in which said write current is set to a large value at the start of said signal writing, and thereafter set to be smaller than said large value at the start of said signal writing, and a write current normal mode execution step in which said write current is not set to be large at the start of said signal writing.

13. The write current control method in a magnetic disk drive according to claim 9, further comprising an environmental temperature detection step of detecting the temperature of an ambient environment, wherein in said write current control step, when said temperature of said ambient environment detected in said environmental temperature detection step becomes lower than or equal to a predetermined value, said write current rise mode execution step is carried out.

14. The write current control method in a magnetic disk drive according to claim 9, further comprising a head flying height detection step of detecting the flying height of said head, wherein in said write current control step, when the flying height of said head detected in said head flying height detection step is greater than or equal to a predetermined value, said write current rise mode execution step is carried out.
